(19) United States
(12) Patent Application Publication
(10) Pub. No.: US 2024/0308381 A1
(43) Pub. Date: Sep. 19, 2024

(54) POWER SUPPLY CONTROL DEVICE AND POWER SUPPLY CONTROL METHOD

(71) Applicant: HONDA MOTOR CO., LTD., Tokyo (JP)

(72) Inventor: Mayo Otani, Tokyo (JP)

(21) Appl. No.: 18/585,448

(22) Filed: Feb. 23, 2024

(30) Foreign Application Priority Data
Mar. 15, 2023 (JP) 2023-040562

(51) Int. Cl. B60L 53/66; B60K 35/10; B60K 35/22; B60L 53/62

(52) U.S. Cl. CPC B60L 53/66; B60K 35/10; B60K 35/22; B60L 53/62; B60K 2360/115; B60K 2360/167; B60K 2360/168; B60L 2250/12; B60L 2250/16; B60L 2250/22

(57) ABSTRACT

A power supply control device includes a power supply control part which controls, from an on-vehicle battery mounted in a vehicle, an external power supply that is a power supply to outside of the vehicle, and which stops the external power supply at a time when a power suppliable remaining amount of the on-vehicle battery becomes less than a predetermined lower limit value during external power supply, a display control part for displaying, on an on-vehicle display device mounted in the vehicle, a lower limit value setting screen that is a screen setting the lower limit value, and a detection part for detecting a start of the external power supply, when a start of the external power supply is detected, wherein the display control part displays, on the on-vehicle display device, a confirmation screen inquiring whether to display the lower limit value setting screen.

### INCORPORATION BY REFERENCE

The present application claims priority under 35 U.S.C. § 119 to Japanese Patent Application No. 2023-040562 filed on Mar. 15, 2023. The content of the application is incorporated herein by reference in its entirety.

### BACKGROUND OF THE INVENTION

### Field of the Invention

The present invention related to a power supply control device and a power supply control method.

### Description of the Related Art

In recent years, in order to be able to secure access to sustainable and advanced energy, in which the access is affordable for a large number of people and the access is reliable, research and development has been performed in relation to a charging power supply in a mobility mounted with a secondary battery that contributes to an improvement in energy efficiency.

Japanese Patent Laid-Open No. 2009-278776 discloses providing a lower limit value of a battery remaining capacity amount, when supplying power from a vehicle battery to outside of a vehicle, and stopping an external power supply in the case where less than this lower limit value.

Incidentally, in technology related to a charging power supply in a mobility mounted with a secondary battery, when an external power supply is performed from a battery mounted in a vehicle to outside of the vehicle, there is a problem of appropriately setting a lower limit value of power that can be supplied of the battery as a stopping condition of the external power supply, so that power that can be supplied of the battery does not to fall below a necessary power for traveling of the vehicle after external power supply.

The present application, in order to solve this problem, has an objective, when an external power supply is performed from an on-vehicle battery to outside of a vehicle, of appropriately setting a lower limit value of power that can be supplied of the on-vehicle battery as a stopping condition of the external power supply. Also, by extension, the present application contributes to an improvement in energy efficiency.

### SUMMARY OF THE INVENTION

One aspect of the present invention is a power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value during external power supply, a display control part for displaying a lower limit value setting screen on an on-vehicle display device mounted in the vehicle, the lower limit value setting screen being a screen for setting the lower limit value, and a detection part for detecting a start of the external power supply, wherein at a time when a start of the external power supply is detected, the display control part displays a confirmation screen on the on-vehicle display device, the confirmation screen for inquiring whether or not to display the lower limit value setting screen.

According to another aspect of the present invention, at a time when any one predetermined prescribed notification screen is displayed on the on-vehicle display device, the display control part does not display the confirmation screen on the on-vehicle display device even at a time when a start of the external power supply is detected.

According to another aspect of the present invention, at a time when the prescribed notification screen is displayed on the on-vehicle display device, and at a time when a start of the external power supply is detected, the display control part displays the confirmation screen on the on-vehicle display device at a time when a display of the prescribed notification screen is finished.

Another aspect of the present invention is a power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value, a detection part for detecting a start of the external power supply, and a setting management part for acquiring the lower limit value input from an input device, and the setting management part for setting the acquired lower limit value in the power supply control part, wherein the power supply control part stores the lower limit value set from the setting management part, and at a time when the lower limit value is not newly set from the setting management part after a start of the external power supply is detected, the power supply control part reads out a lower limit value set and stored by the setting management part at a time of a previous external power supply, and at a time when a power suppliable remaining amount of the on-vehicle battery becomes less than the read-out lower limit value, the power supply control part stops the external power supply.

Another aspect of the present invention is a power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value, and a setting management part for acquiring the lower limit value input from an input device, and the setting management part for setting the acquired lower limit value in the power supply control part, wherein at a time when the input lower limit value is a value exceeding a present power suppliable remaining amount of the on-vehicle battery, the setting management part does not set the acquired lower limit value in the power supply control part.

According to another aspect of the present invention, at a time when the lower limit value is a value equal to or more than a present power suppliable remaining amount, the lower limit value being input by a user of the vehicle by the input device, the setting management part notifies to the user a notification of not accepting a setting of the input lower limit value.

According to another aspect of the present invention, at a time when the lower limit value is a value less than a prescribed limit value, the lower limit value being input by a user of the vehicle by the input device, the setting management part notifies to the user a notification of not accepting a setting of the input lower limit value.

According to another aspect of the present invention, the setting management part calculates a power suppliable remaining amount of the on-vehicle battery necessary for the vehicle to travel a distance from a present position to a destination, and the setting management part determines a value of the calculated power suppliable remaining amount as the limit value.

According to another aspect of the present invention, the setting management part calculates a power suppliable remaining amount of the on-vehicle battery necessary for the vehicle to travel a distance from a present position to a nearest energy refill station, and the setting management part determines a value of the calculated power suppliable remaining amount as the limit value.

According to another aspect of the present invention, the setting management part estimates a power consumption of the vehicle in an environment based on environmental information including a temperature of a region, the environment being shown by the environment information and the region including a present position of the vehicle, and the setting management part calculates the necessary power suppliable remaining amount of the on-vehicle battery by using the estimated power consumption.

Another aspect of the present invention is a power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value, a detection part for detecting a start of the external power supply, and a setting management part for acquiring the lower limit value input from an input device, and the setting management part for setting the acquired lower limit value in the power supply control part, wherein at a time when a power suppliable remaining amount of the on-vehicle battery becomes less than a presently set lower limit value, the power supply control part stops the external power supply until the lower limit value is newly set from the setting management part.

According to another aspect of the present invention, the input device is an input device included in a portable terminal of a user of the vehicle.

According to another aspect of the present invention, at a time when the external power supply stops, the power supply control part transmits a notification of a power supply stop to a portable terminal of a user of the vehicle.

Another aspect of the present invention is a power supply control method performed by a computer of a power supply control device, the power supply control method including a power supply step for controlling an external power supply from an on-vehicle battery mounted in a vehicle, the external power supply being a power supply to outside of the vehicle, and the power supply step for stopping the external power supply at a time when a power suppliable remaining amount of the on-vehicle battery becomes less than a predetermined lower limit value during external power supply, a display control step for displaying a lower limit value setting screen on an on-vehicle display device mounted in the vehicle, the lower limit value setting screen being a screen for setting the lower limit value, and a detection step for detecting a start of the external power supply, wherein in the display control step, at a time when a start of the external power supply is detected in the detection step, a confirmation screen is displayed on the on-vehicle display device, the confirmation screen for inquiring whether or not to display the lower limit value setting screen.

### Advantageous Effect of Invention

According to the aspect of the present invention, when an external power supply is performed from an on-vehicle battery to outside of a vehicle, a lower limit value of power that can be supplied of the on-vehicle battery can be appropriately set as a stopping condition of the external power supply.

### BRIEF DESCRIPTION OF THE DRAWINGS

FIG. 1 is a figure showing an example of a scene in which a vehicle is used, the vehicle including a power supply control device, relating to an embodiment of the present invention;

FIG. 2 is a figure showing a configuration of a power supply control device;

FIG. 3 is a figure showing a configuration of a portable terminal cooperating with a power supply control device;

FIG. 4 is a flow chart showing procedures of operations in a power supply control device;

FIG. 5 is a flow chart showing procedures of operations in a power supply control device;

FIG. 6 is a flow chart showing procedures of a previous lower limit value determination process shown in the flow chart of FIG. 5;

FIG. 7 is a figure showing an example of a confirmation screen displayed by a display control part;

FIG. 8 is a figure showing an example of a lower limit value setting screen displayed by a display control part; and

FIG. 9 is a figure showing an example of a caution notification displayed on a lower limit value setting screen by a display control part.

### DETAILED DESCRIPTION OF THE PREFERRED EMBODIMENTS

Hereinafter, embodiments of the present invention will be described by referring to the figures.

### 1. Embodiment

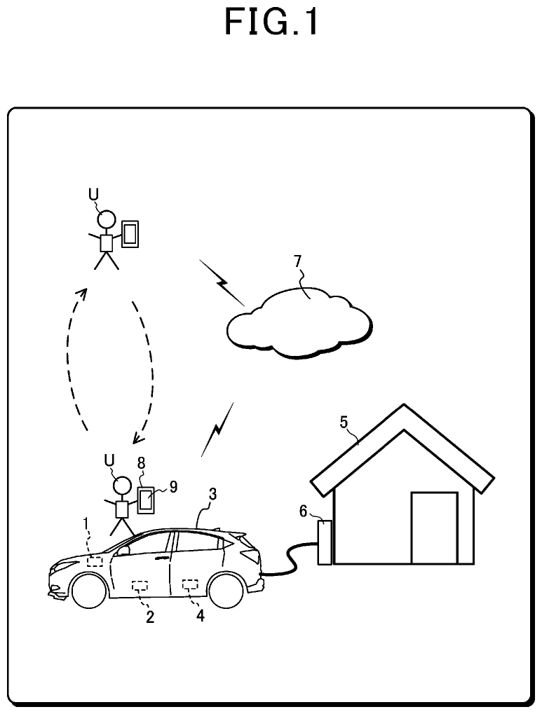

FIG. 1 is a figure showing an example of a scene in which a vehicle 3 is used, the vehicle 3 including a power supply control device 1, according to an embodiment of the present invention. The vehicle 3 is a vehicle that travels by driving a drive motor 4 by a power supply from an on-vehicle battery 2, and in the present embodiment, the vehicle 3 is, for example, an electric vehicle.

The power supply control device 1 controls an external power supply from the on-vehicle battery 2, the external power supply being a supply of power to outside of the vehicle 3. For example, a user U of the vehicle 3 performs an external power supply from the on-vehicle battery 2 of the vehicle 3 to a building battery 6 of a building 5 such as a log house, at a journey destination moved by the vehicle 3, the building 5 not receiving a power supply from a power supply network of a power company or the like. Note that an external power supply to the building battery 6 is an example, and the on-vehicle battery 2 of the vehicle 3 can perform an external power supply to an arbitrary device or unit outside of the vehicle 3, as long as electrical conditions are matching.

The power supply control device 1 can communicate with a portable terminal 8 of the user U of the vehicle 3, via a communication network 7 outside of the vehicle 3. The power supply control device 1 performs a reception of information for an external power supply operation, between the portable terminal 8 carried by the user U. In this way, the user U can perform an instruction (specifically, a setting of a lower limit value Lv, which will be described below) for an external power supply operation to the power supply control device 1, even in the case where the user U moves to a position separated from the vehicle 3 after starting an external power supply to the building battery 6.

### [1.1 Power Supply Control Device]

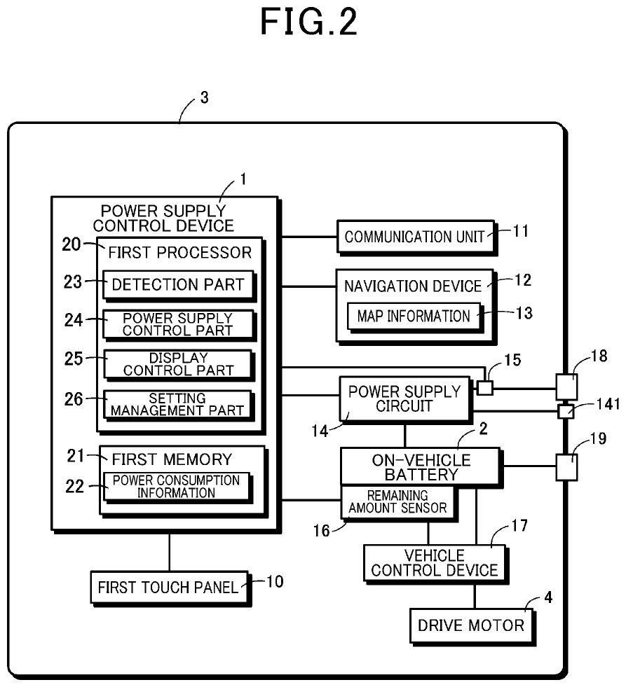

FIG. 2 is a figure showing a configuration of the power supply control device 1.

The power supply control device 1 connects a first touch panel 10, a communication unit 11, a navigation device 12, a power supply circuit 14, a power supply sensor 15, and a remaining amount sensor 16, mounted in the vehicle. The on-vehicle battery 2 drives the vehicle 3, by supplying power to the drive motor 4 via a vehicle control device 17 (computer including a processor and a memory). At the time when an external unit (not illustrated) outside of the vehicle 3 is connected to an external power supply connector 18 and a power supply switch 141 is turned ON, the power supply circuit 14 starts an external power supply from the on-vehicle battery 2 to the external unit. Moreover, at the time when the power supply switch 141 is turned OFF, or at the time when a stop of an external power supply from the power supply control device 1 is instructed, the power supply circuit 14 finishes an external power supply from the on-vehicle battery 2 to the external unit.

The power supply control device 1 detects a start and finish of an external power supply, by the power supply sensor 15 provided on an output line of an external power supply of the power supply circuit 14. The power supply sensor 15 is, for example, a current sensor.

The communication unit 11 is a wireless communication device (transmitter/receiver, circuit) for the power supply control device 1 to communicate with an external device such as the portable terminal 8 via the communication network 7.

The remaining amount sensor 16 detects a power suppliable remaining amount of the on-vehicle battery 2. In the present embodiment, the on-vehicle battery 2 is, for example, a hydrogen fuel cell that operates, for example, by hydrogen fuel refilled from a fuel port 19, and the remaining amount sensor 16 detects a remaining amount of hydrogen fuel as a power suppliable remaining amount of the on-vehicle battery 2.

Instead of this, the on-vehicle battery 2 may be a storage battery (secondary battery) directly charged from outside of the vehicle 3. In this case, the remaining amount sensor 16 can be a sensor for detecting a charging power remaining amount (SOC, State of Charge) of the on-vehicle battery 2 as a power suppliable remaining amount, the on-vehicle battery 2 being a storage battery.

The navigation device 12 includes a computer having a processor and a memory, and the navigation device 12 performs route guidance to a destination set by a user of the vehicle 3. The navigation device 12 acquires information of a present position of the vehicle 3 by a GNSS sensor (not illustrated), in accordance with conventional technology, and the navigation device 12 performs route guidance to the destination, based on map information 13 stored in the memory. In the present embodiment, the map information 13 includes position information of an energy refill station (in the present embodiment, a hydrogen station).

The power supply control device 1 controls an external power supply operation of the on-vehicle battery 2 by performing an instruction to the power supply circuit 14.

The power supply control device 1 includes a first processor 20 and a first memory 21. The first memory 21 is configured, for example, by a volatile and/or non-volatile semiconductor memory and/or by a hard disk device. Power consumption information 22 is stored beforehand in the first memory 21, the power consumption information 22 being information of power consumption characteristics of the vehicle 3. Here, a power consumption is called a travel distance of the vehicle 3 per power supply amount from the on-vehicle battery 2. Alternatively, at the time when the on-vehicle battery 2 is a hydrogen fuel battery such as in the present embodiment, a travel distance of the vehicle 3 per power consumption amount of hydrogen fuel may be used as a power consumption. In the present embodiment, the power consumption characteristics include information for a dependency of a power consumption with respect to an environmental temperature of the vehicle 3.

The first processor 20 is, for example, a computer that includes a CPU. The first processor 20 may be constituted by having a ROM to which programs are written, and a RAM for temporary storage of data. Also, the first processor 20 includes a detection part 23, a power supply control part 24, a display control part 25, and a setting management part 26, as functional elements or functional units.

These functional elements included in the first processor 20 are implemented, for example, by the first processor 20 that is a computer, the first processor 20 executing a program stored in the first memory 21. Note that the program can be stored in an arbitrary computer-readable storage medium. Instead of this, all or part of the functional elements included in the first processor 20 can be respectively constituted of hardware including one or more electronic circuit components.

The detection part 23 detects a start and finish of an external power supply from the on-vehicle battery 2 to outside of the vehicle 3. For example, the detection part 23 detects a start and finish of the external power supply, based on a sensor output from the power supply sensor 15.

The power supply control part 24 controls an external power supply from the on-vehicle battery 2 to outside of the vehicle 3. At the time when a power suppliable remaining amount of the on-vehicle battery 2 becomes less than a predetermined lower limit value Lv during an external power supply, the power supply control part 24 stops an external power supply. The lower limit value Lv is set by the setting management part 26, which will be described below.

The power supply control part 24 stores the lower limit value Lv set by the setting management part 26.

For example, at the time when the lower limit value Lv is not newly set from the setting management part 26 after a start of an external power supply is detected by the detection part 23, the power supply control part 24 reads out the lower limit value Lv set and stored by the setting management part 26 at the time of a previous external power supply. Also, at the time when a power suppliable remaining amount of the on-vehicle battery 2 becomes less than the read-out lower limit value Lv in the present external power supply, the power supply control part 24 stops an external power supply. In this way, since an external power supply is stopped by using the lower limit value Lv at the time of a previous external power supply operation, even in the case where the user U does not set the lower limit value Lv at the time of a start of an external power supply, a situation can be avoided in which a power suppliable remaining amount of the on-vehicle battery 2 is depleted after an external power supply, and the vehicle 3 can no longer travel.

Moreover, for example, at the time when the lower limit value Lv is set from the setting management part 26, the power supply control part 24 stores the set lower limit value Lv, until a start of a new external power supply is detected by the detection part 23, after finishing a previous external power supply operation. Also, at the time when a start of a new external power supply (namely, the present external power supply) is detected by the detection part 23, and at the time when the new lower limit value Lv is not set from the setting management part 26, the power supply control part 24 reads out the stored lower limit value Lv, and the power supply control part 24 uses the read-out lower limit value Lv as a stopping condition of the present external power supply operation. Namely, at the time when a power suppliable remaining amount of the on-vehicle battery 2 becomes less than the read-out lower limit value Lv in the present external power supply, the power supply control part 24 stops an external power supply. In this way, since a user can set an appropriate lower limit value beforehand, prior to an external power supply starting, the convenience of the user is improved.

Moreover, at the time when an external power supply is stopped, the power supply control part 24 transmits a notification of a power supply stop to the portable terminal 8 of the user U of the vehicle 3. In this way, in the power supply control device 1, since the user U can know that an external power supply operation is stopped even if the user U is separated from the vehicle 3, the convenience of the user U is improved. For example, in a tourist spot, in the case where the user U uses the time of an external power supply to walk separated from the vehicle 3, after an external power supply starts from the vehicle 3 to the building battery 6 of the building 5 such as a log house, since the user U can know a stop of an external power supply during the walk, the user U can return to the building 5, without consuming an unnecessarily long time for the walk.

The display control part 25 displays a lower limit value setting screen on the first touch panel 10, the lower limit value setting screen being a screen for setting the lower limit value Lv. Here, the first touch panel 10 corresponds to a vehicle display device mounted in the vehicle 3, in the present disclosure.

For example, the display control part 25 displays a menu screen on the first touch panel 10, in accordance with conventional technology, the menu screen arranging activation buttons for activating various functions of the vehicle 3, and at the time when the user U operates a prescribed activation button, the display control part 25 can display the lower limit value setting screen on the first touch panel 10.

In the present embodiment, at the time when a start of an external power supply is detected by the detection part 23, the display control part 25 displays a confirmation screen on the first touch panel 10, the confirmation screen for inquiring whether or not to display the lower limit value setting screen. At the time when the user U instructs a display of the lower limit value setting screen as a response to the confirmation screen, the display control part 25 displays the lower limit value setting screen. In this way, when an external power supply is performed from the on-vehicle battery 2 to outside of the vehicle 3, the user U can perform, without forgetting, a setting of the lower limit value Lv, the lower limit value Lv being a stopping condition of an external power supply. Accordingly, for example, a situation can be avoided in which a power suppliable remaining amount of the on-vehicle battery 2 is depleted after an external power supply due to forgetting to set the lower limit value Lv, and the vehicle 3 can no longer travel.

Note that the confirmation screen may be, for example, other than a screen for displaying a message that directly inquires the necessity or not of a display of the lower limit value setting screen such as [Do You Want To Display A Setting Screen?], a message that indirectly inquires the necessity or not of a display of the lower limit value setting screen, such as inquiring the necessity or not of a screen movement to a lower limit value setting screen such as [Do You Want To Set A Lower Limit Value?].

However, even at the time when a start of an external power supply is detected while any one predetermined prescribed notification screen is displayed on the first touch panel 10, the display control part 25 does not display the confirmation screen on the first touch panel 10. Namely, at the time when a start of an external power supply is detected, and at the time when a predetermined prescribed notification screen is not displayed on the first touch panel 10, the display control part 25 displays the confirmation screen on the first touch panel 10. For example, the notification screen can be a failure notification screen for notifying a failure such as a hydraulic abnormality or a system abnormality, or the notification screen can be a warning notification screen for warning an unperformed operation such as forgetting to apply a parking brake. In this way, a situation can be avoided in which a notification with a high priority is no longer conveyed to the user U by a display of the confirmation screen.

For example, the display control part 25 can display the notification screen, based on information from various electronic control devices, which are not illustrated, the electronic control devices being mounted in the vehicle 3. For example, the electronic control devices can be various operation control devices for detecting a user operation of an accelerator, brake, parking brake, steering wheel or the like of the vehicle 3, or the electronic control devices can be various travel control devices for performing a hydraulic mechanism, motor control, battery control or the like necessary for traveling of the vehicle 3.

At the time when the prescribed notification screen is displayed on the first touch panel 10, and at the time when a start of an external power supply is detected in the detection part 23, the display control part 25 displays the confirmation screen on the first touch panel 10 at the time when a display of the prescribed notification screen is finished. For example, at the time when a confirmation button is operated, the confirmation button being displayed on the notification screen by the display control part 25, or at the time when a non-performed operation notified by the notification screen is performed (in the above example, at the time when a locking operation of a parking brake is performed), the notification screen can be finished. In this way, since the confirmation screen is displayed at the time when it is no longer necessary to display the notification screen, forgetting to input the lower limit value Lv can be prevented, while surely performing a conveyance of a notification with high priority to the user U, the lower limit value Lv being a stopping condition of an external power supply.

The setting management part 26 acquires the lower limit value Lv input from an input device, and the setting management part 26 sets the acquired lower limit value Lv in the power supply control part 24. The input device can be the first touch panel 10 mounted in the vehicle 3, or the input device can be the second touch panel 9 as an input device included in the portable terminal 8 of the user U. For example, at the time when the user U of the vehicle 3 inputs the lower limit value Lv, on the lower limit value setting screen displayed on the first touch panel 10 by the display control part 25, the setting management part 26 acquires the input lower limit value Lv.

Alternatively, at the time when a lower limit value setting instruction is received from the portable terminal 8 of the user U via the communication unit 11, the setting management part 26 acquires the lower limit value Lv included in the received lower limit value setting instruction. As stated below, at the time when the user U inputs the lower limit value Lv from the setting screen displayed on the second touch panel 9 by the vehicle management app, for example, the portable terminal 8 transmits the lower limit value setting instruction to the vehicle 3, the lower limit value setting instruction including the lower limit value Lv. In this way, since the user U can input the lower limit value Lv even at a location where the user U is separated from the vehicle 3, the convenience of the user U is improved.

At the time when the lower limit value Lv input or acquired from the first touch panel 10 or the second touch panel 9 is a value exceeding a present power suppliable remaining amount of the on-vehicle battery 2, the first touch panel 10 or the second touch panel 9 each being an input device, the setting management part 26 does not set the acquired lower limit value Lv in the power supply control part 24. Namely, the setting management part 26 sets the acquired lower limit value Lv in the power supply control part 24, as a condition of the input or acquired lower limit value Lv being equal to or less than the present power suppliable remaining amount of the on-vehicle battery 2. Here, the present power suppliable remaining amount of the on-vehicle battery 2 can be acquired based on sensor information from the remaining amount sensor 16. In this way, an inconvenient situation can be avoided in which the set lower limit value Lv exceeds the present power suppliable remaining amount of the on-vehicle battery 2, and an external power supply operation immediately stops.

Moreover, at the time when the lower limit value Lv input on the lower limit value setting screen by the user U, the lower limit value setting screen being displayed on the first touch panel 10, or the lower limit value Lv input on the second touch panel 9 in a vehicle management app executed by the portable terminal 8, is a value exceeding the present power suppliable remaining amount, the setting management part 26 performs an instruction to the display control part 25, the setting management part 26 displays a caution notification on the first touch panel 10 or the second touch panel 9 used for the input, the caution notification being that a setting of the input lower limit value is not accepted, and the setting management part 26 performs a notification to the user U. A display of the caution notification to the second touch panel 9 of the portable terminal 8 is performed, for example, by having the setting management part 26 transmit the caution notification to the portable terminal 8.

In this way, since the lower limit value Lv being inappropriate is notified to the user, the lower limit value Lv being input by the user U, for example, the power supply control device 1 can prevent an input error of the lower limit value by the user, and the convenience of the user is improved.

Moreover, the setting management part 26 determines whether or not the lower limit value input to the lower limit value setting screen by the user U of the vehicle 3, the lower limit value setting screen being displayed on the first touch panel 10, or the lower limit value Lv input to the second touch panel 9 in a vehicle management app executed by the portable terminal 8, is a value less than a prescribed limit value Cv. Also, at the time when the input lower limit value Lv is a value less than the limit value Cv, the setting management part 26 does not set the acquired lower limit value Lv to the power supply control part 24. Namely, the setting management part 26 sets the acquired lower limit value Lv in the power supply control part 24, as a condition of the input or acquired lower limit value Lv being equal to or more than the limit value. Moreover, the setting management part 26 performs an instruction to the display control part 25, the setting management part 26 displays a caution notification on the first touch panel 10 or the second touch panel 9 used for the input, the caution notification being that a setting of the input lower limit value is not accepted, and the setting management part 26 performs a notification to the user U.

In this way, in the power supply control device 1, if the lower limit value Lv input by the user U is too small, a situation can be avoided in which hardly any power suppliable remaining amount of the on-vehicle battery remains after an external power supply, and afterwards the vehicle 3 can no longer travel to a planned location.

As an example of the limit value Cv, the setting management part 26 calculates a power suppliable remaining amount of the on-vehicle battery 2 necessary for traveling a distance to a destination, and the setting management part 26 determines a value of the calculated power suppliable remaining amount as the limit value Cv. In this way, a user can set an appropriate lower limit value Lv, so that a power suppliable remaining amount necessary for the vehicle 3 to travel to a destination after an external power supply can be secured.

Specifically, the setting management part 26 acquires, from the navigation device 12, information of a distance from a present position of the vehicle 3 to a destination, the destination being set by the navigation device 12. Also, the setting management part 26 calculates a power suppliable remaining amount of the on-vehicle battery 2 necessary for traveling a distance to the destination, based on the distance acquired from the navigation device 12 and the power consumption information 22 of the vehicle 3 stored in the first memory 21.

As another example of the limit value Cv, the setting management part 26 calculates a power suppliable remaining amount of the on-vehicle battery 2 necessary for the vehicle 3 to travel a distance from a present position to a nearest energy refill station, and the setting management part 26 determines a value of the calculated power suppliable remaining amount as the limit value Cv. Here, the energy refill station can be a hydrogen station at the time when the on-vehicle battery 2 is a hydrogen fuel battery, and the energy refill station can be a refill station at the time when the on-vehicle battery 2 is a secondary battery. In this way, the user U can set an appropriate lower limit value, so that a power suppliable remaining amount of the on-vehicle battery 2 necessary for the vehicle 3 to travel to a nearest energy refill station after an external power supply can be secured.

Specifically, the setting management part 26 acquires, from the navigation device 12, information of a distance from a present position of the vehicle 3 to a nearest energy refill station. For example, the navigation device 12 calculates a distance to the nearest energy refill station, from position information of energy refill stations included in the map information 13. Also, the setting management part 26 calculates a power suppliable remaining amount of the on-vehicle battery 2 necessary for traveling a distance to the nearest energy refill station, based on the distance acquired from the navigation device 12 and the power consumption information 22 of the vehicle 3 stored in the first memory 21.

For example, the setting management part 26 can determine the limit value Cv, based on a setting input by the user U beforehand via the first touch panel 10, and based on either a distance to a destination or a distance to a nearest energy refill station. Alternatively, at the time when the present power suppliable amount exceeds a power suppliable remaining amount necessary for traveling a distance to a destination, the setting management part 26 can determine a power suppliable remaining amount necessary for traveling a distance to the destination as the limit value Cv, and at the time when this is not the case, the setting management part 26 can determine the limit value Cv based on a distance to a nearest energy refill station.

Moreover, when determining the limit value Cv, the setting management part 26 estimates a power consumption of the vehicle 3 in an environment shown by environment information of a region including a present position of the vehicle 3, based on this environment information. Also, the setting management part 26 uses the estimated power consumption, and the setting management part 26 calculates a power suppliable remaining amount of the on-vehicle battery 2 necessary for traveling a distance to the destination or nearest energy refill station.

For example, a temperature of this region is included in the environment information, and the setting management part 26 can perform an estimation of the power consumption, based on information for a dependency with respect to an environmental temperature of power consumption characteristics shown by the power consumption information 22. Alternatively, information for a weather state or road congestion is included in the environment information, and the setting management part 26 may correct the power consumption shown by the power consumption information 22, by a correction coefficient representing an extent of power consumption deterioration dependent on a weather state (for example, rainy weather, strong winds and the like) and/or road congestion, and the setting management part 26 may perform an estimation of the power consumption. The correction coefficient can be predetermined in accordance with the weather state or extent of congestion.

In this way, in the power supply control device 1, since a power suppliable remaining amount used as a limit value (namely, a necessary power suppliable remaining amount after an external power supply) can be calculated based on an environmental condition such as temperature that has an influence on the power consumption of the vehicle, the limit value can be appropriately set. As a result of this, in the power supply control device 1, a situation occurring can be avoided in which the vehicle cannot travel to a destination or nearest energy refill station, regardless of the user setting the lower limit value Lv equal to or more than the limit value.

Note that the environment information can be acquired, for example, from a weather data server or traffic information server, which are not illustrated, via the communication unit 11, the weather data server or traffic information server being outside of the vehicle 3.

The setting management part 26 transmits information of a present power suppliable remaining amount and/or information of the limit value Cv to the portable terminal 8, in response to receiving an information request from the portable terminal 8.

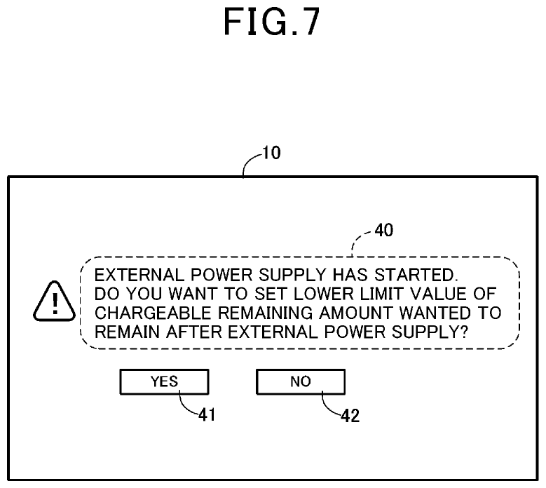

FIG. 7 is a figure showing an example of a confirmation screen displayed on the first touch panel 10 by the display control part 25 at the time when a start of an external power supply is detected. In the example shown in FIG. 7, a confirmation message 40, a YES button 41, and a NO button 42 are displayed on a display screen of the first touch panel 10. The confirmation message 40, [Do You Want to Set Lower Limit Value of Chargeable Remaining Amount Wanted to Remain After External Power Supply?], the message indirectly inquiring the necessity or not of a display of the lower limit value setting screen, is displayed. At the time when the user U wants to display the lower limit value setting screen and the user U wants to set the lower limit value Lv, the user U can respond by operating the YES button 41. Alternatively, at the time when the user U does not set the lower limit value Lv this time, and it is not necessary to display the lower limit value setting screen, the user U can respond by operating the NO button 42.

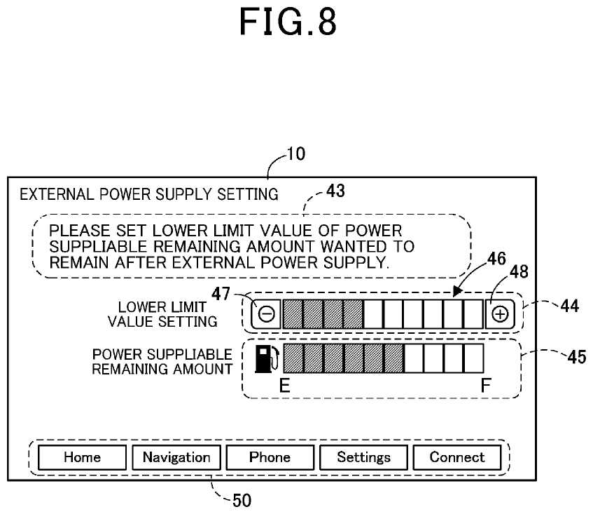

FIG. 8 is a figure showing an example of the lower limit value setting screen displayed on the first touch panel 10 by the display control part 25. In the example shown in FIG. 8, a message 43 for urging a setting of the lower limit value Lv, a lower limit value adjustment bar 44 for adjusting and setting the lower limit value Lv, a remaining amount display bar 45 for showing a present power suppliable remaining amount of the on-vehicle battery 2, and a button group 50 for moving a screen display to a screen related to various functions, are displayed.

A gauge 46 representing a size of a setting value of the lower limit value Lv, a minus button 47 for decreasing the lower limit value Lv, and a plus button 48 for increasing the lower limit value Lv, are displayed on the lower limit value adjustment bar 44. For example, the scale of the gauge 46 of the lower limit value adjustment bar 44 can be the same as the scale of the remaining amount display bar 45. The user U can use the minus button 47 and/or the plus button 48, and the user U can set the lower limit value Lv to a desired value (namely, input the lower limit value Lv). For example, the setting management part 26 acquires the lower limit value Lv after an increase/decrease, every time the user U uses the minus button 47 and the plus button 48, and the user U increases/decreases the lower limit value Lv. The input lower limit value Lv can be secured, by the user U operating any one button of the button group 50 (for example, the “Home” button on the left end of the figure).

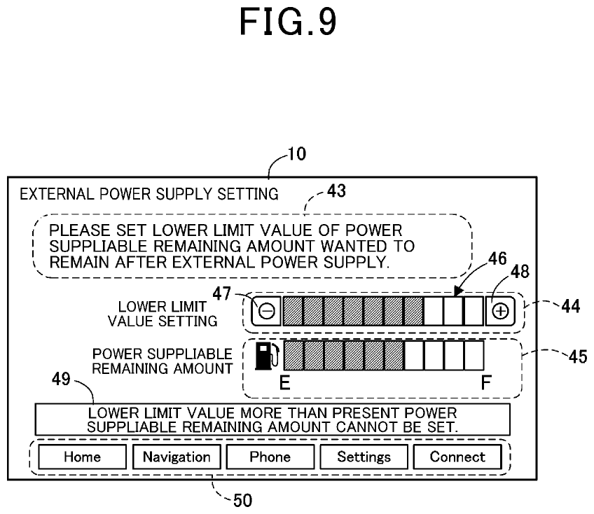

FIG. 9 is a figure for showing an example of a caution notification, in the case where the lower limit value Lv set in the lower limit value setting screen is equal to or more than a present power suppliable remaining amount of the on-vehicle battery 2, the caution notification being displayed on the first touch panel 10 by having the setting management part 26 perform an instruction to the display control part 25. Note that elements the same as the screen constituent elements shown in FIG. 8, from among the screen constituent elements shown in FIG. 9, are shown by using the same reference numerals as the reference numerals in FIG. 8, and an explanation of the above-stated FIG. 8 will be utilized.

In FIG. 9, in addition to the lower limit value setting screen shown in FIG. 8, a caution notification 49 is displayed. For example, such a caution notification 49 is displayed at the time when the user U uses the minus button 47 and the plus button 48 of the lower limit value adjustment bar 44, and the user U increases/decreases the lower limit value Lv in a value range exceeding a present power suppliable remaining amount shown by the remaining amount display bar 45.

Note that in the case where the user U uses the minus button 47 and the plus button 48 of the lower limit value adjustment bar 44, and the user U increases/decreases the lower limit value Lv in a value range less than the above-stated limit value Cv, a caution notification of a mode the same as the mode of the caution notification 49 can be displayed on the first touch panel 10, by the setting management part 26. The caution notification of this case can include a message such as “Lower Limit Value Less Than Necessary Limit Value for Traveling to Destination Cannot be Set”.

### [1.2 Configuration of the Portable Terminal]

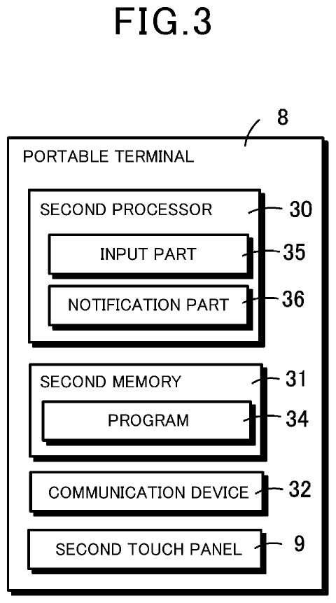

FIG. 3 is a figure showing a configuration of the portable terminal 8.

The portable terminal 8 has a second processor 30, a second memory 31, a communication device 32, and a second touch panel 9.

The second memory 31 is configured, for example, by a volatile and/or non-volatile semiconductor memory. The communication device 32 is a wireless communication device (transmitter/receiver, circuit) for the portable terminal 8 to communicate with a device such as the power supply control device 1 of the vehicle 3 via the communication network 7.

The second touch panel 9 is controlled by the second processor 30, the second touch panel 9 displays information from a user, and the second touch panel 9 acquires an input from the user. The second touch panel 9 corresponds to an input device included in the portable terminal, in the present disclosure.

The second processor 30 is, for example, a computer that includes a CPU. The second processor 30 may be constituted by having a ROM to which programs are written, and a RAM for temporary storage of data. Also, the second processor 30 includes an input part 35 and a notification part 36, as functional elements or functional units.

These functional elements included in the second processor 30 are implemented, for example, by the second processor 30 that is a computer, the second processor 30 executing a program 34 stored in the second memory 31. The program 34 can be downloaded from a server device (not illustrated) connected to the communication network 7. Note that the program 34 can be stored in an arbitrary computer-readable storage medium.

The program 34 is, for example, an application program. Here, an application activated by the program 34 being executed is called a vehicle management app. The second processor 30 displays an activation icon of the vehicle management app on the second touch panel 9, in accordance with conventional technology, and at the time when a corresponding activation icon is operated, the second processor 30 executes the program 34, and the input part 35 and the notification part 36 are implemented within the second processor 30 in order to execute functions of the vehicle management app.

The input part 35 acquires the lower limit value Lv input from the second touch panel 9 that is an input device, and the input part 35 transmits a lower limit value setting instruction to the power supply control device 1. Specifically, the input part 35 displays a setting screen on the second touch panel 9, the setting screen being similar to the lower limit value setting screen (for example, the screen shown in FIG. 8) displayed on the first touch panel 10 by the display control part 25 of the power supply control device 1. At this time, the input part 35 can transmit an information request to the power supply control device 1, the input part 35 can acquire information of a present power suppliable remaining amount and the limit value Cv of the on-vehicle battery 2 from the power supply control device 1, and the input part 35 can display the acquired present power suppliable remaining amount and limit value Cv on the setting screen.

The user U of the vehicle 3 inputs the lower limit value Lv by operating the second touch panel 9, the setting screen being displayed on the second touch panel 9. The input part 35 acquires the lower limit value Lv, and the input part 35 transmits a lower limit value setting instruction to the power supply control device 1, the lower limit value setting instruction including the acquired lower limit value Lv.

As stated above, the setting management part 26 of the power supply control device 1 receiving the lower limit value setting instruction extracts and acquires the lower limit value Lv included in the lower limit value setting instruction, and the setting management part 26 sets the acquired lower limit value Lv on the power supply control part 24. At this time, at the time when the lower limit value Lv input to the second touch panel 9 by the user U exceeds a present power suppliable remaining amount of the on-vehicle battery 2, and/or at the time when the lower limit value Lv is less than the limit value Cv, the setting management part 26 of the power supply control device 1 transmits a caution notification to the portable terminal 8.

At the time when a caution notification is received from the power supply control device 1, the input part 35 displays the received caution notification on the second touch panel 9.

At the time when a notification of a power supply stop of an external power supply is received from the power supply control device 1, the notification part 36 displays the received notification of a power supply stop on the second touch panel 9.

### [1.3 Operations of the Power Supply Control Device]

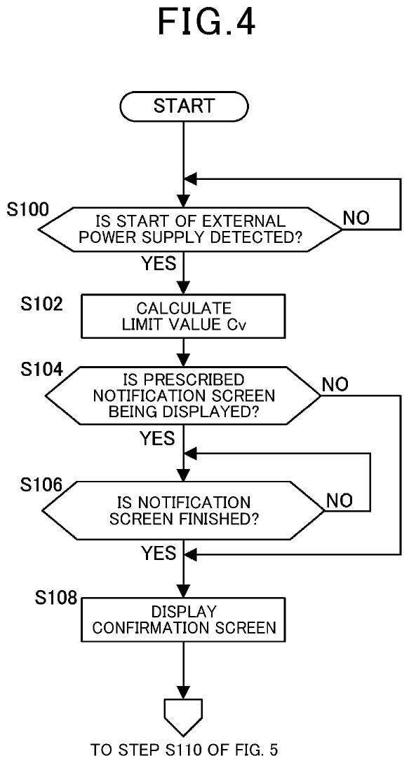

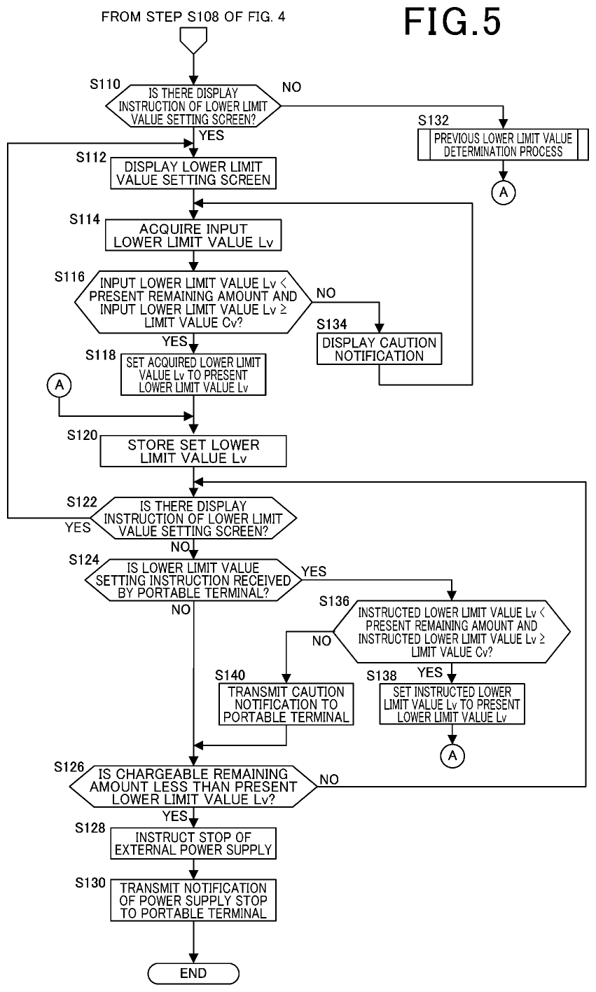

Next, operations of the power supply control device 1 will be described. FIG. 4 and FIG. 5 are each a flow chart showing procedures of operations in the power supply control device 1. The processes shown in each of FIG. 4 and FIG. 5 are repeatedly executed.

With reference to FIG. 4, when the process starts, the detection part 23 of the power supply control device 1 determines whether or not an external power supply is started, based on a sensor input from the power supply sensor 15 (S100). Then, at the time when an external power supply is not started (S100, NO), the detection part 23 repeats the process by returning to step S100, and the detection part 23 waits for an external power supply to start.

On the other hand, at the time when an external power supply is started (S100, YES), the setting management part 26 calculates the limit value Cv, based on a distance to a destination of the vehicle 3 set in the navigation device 12, or based on a distance to a nearest energy refill station set in the navigation device 12, the limit value Cv being a power suppliable remaining amount wanted to remain at the time of finishing an external power supply (S102).

Next, the display control part 25 determines whether or not a prescribed notification screen is being displayed on the first touch panel 10 mounted in the vehicle (S104). As stated above, the notification screen can be, for example, a warning notification screen, a failure notification screen or the like. Then, at the time when a notification screen is being displayed (S104, YES), the display control part 25 determines whether or not a display of the notification screen is finished (S106).

Then, at the time when the notification screen is not finished (S106, NO), the display control part 25 repeats the process by returning to step S106, and the display control part 25 waits for a display of the notification screen to finish. On the other hand, at the time when a display of the notification screen is finished (S106, YES), the display control part 25 displays a confirmation screen (FIG. 7) on the first touch panel 10, the confirmation screen for inquiring whether or not to display the lower limit value setting screen (S108). The user U inputs an instruction of whether or not to display the lower limit value setting screen, in the confirmation screen.

Moreover, at the time when the prescribed notification screen is not being displayed in step S104 (S104, NO), the display control part 25 moves the process to step S108.

To continue, with reference to FIG. 5, the display control part 25 determines whether or not a display instruction of the lower limit value setting screen is input, in the confirmation screen (S110). Then, at the time when a display instruction of the lower limit value setting screen is input (S110, YES), the display control part 25 displays the lower limit value setting screen on the first touch panel 10 (S112). The user U inputs the lower limit value Lv, for the displayed lower limit value setting screen. The setting management part 26 acquires the input lower limit value Lv (S114). Hereinafter, the input lower limit value Lv will be called the input lower limit value Lv.

To continue, the setting management part 26 determines whether or not the input lower limit value Lv is less than a present power suppliable remaining amount (hereinafter, called the present remaining amount) of the on-vehicle battery 2 and the input lower limit value Lv is equal to or more than the limit value Cv (S116). Then, at the time when the input lower limit value Lv is less than a present remaining amount and the input lower limit value Lv is equal to or more than the limit value Cv (S116, YES), the setting management part 26 sets the input lower limit value Lv in the power supply control part 24 as the lower limit value Lv (hereinafter, called the present lower limit value Lv) used in a present external power supply operation (S118). The power supply control part 24 stores the set lower limit value Lv in the first memory 21 (S120). Afterwards, the display control part 25 displays a menu screen on the first touch panel 10, the menu screen arranging activation buttons for activating various functions of the vehicle 3.

Next, the display control part 25 determines whether or not the user U operates a prescribed activation button of the menu screen, and the user U inputs a display instruction of the lower limit value setting screen (S122). Then, at the time when a display instruction of the lower limit value setting screen is input (S122, YES), the display control part 25 repeats the process by returning to step S112.

On the other hand, at the time when a display instruction of the lower limit value setting screen is not input (S122, NO), the setting management part 26 determines whether or not a lower limit value setting instruction is received from the portable terminal 8 (S124). Then, at the time when a lower limit value setting instruction is not received (S124, NO), the power supply control part 24 determines whether or not a power suppliable remaining amount of the on-vehicle battery 2 is less than a present lower limit value Lv (S126). Then, at the time when a power suppliable remaining amount is less than a present lower limit value Lv (S126, YES), the power supply control part 24 instructs a stop of a power supply to the power supply circuit 14 (S128). Moreover, the power supply control part 24 transmits a notification of a power supply stop to the portable terminal 8 (S130), and the power supply control part 24 finishes the present process.

On the other hand, at the time when the lower limit value setting instruction is received by the portable terminal 8 in step S124 (S124, YES), the setting management part 26 determines whether or not the lower limit value Lv (hereinafter, called the instructed lower limit value Lv) is less than a present remaining amount of the on-vehicle battery 2 and the lower limit value Lv is equal to or more than the limit value Cv, the lower limit value Lv included in the received lower limit value setting instruction (S136). Then, at the time when the instructed lower limit value Lv is less than a present remaining amount of the on-vehicle battery 2 and the instructed lower limit value Lv is equal to or more than the limit value Cv (S136, YES), the setting management part 26 sets the instructed lower limit value Lv in the power supply control part 24 as a present lower limit value Lv (S138), and the setting management part 26 moves the process to step S120.

On the other hand, at the time when the instructed lower limit value Lv is not less than a present remaining amount of the on-vehicle battery 2 or the instructed lower limit value Lv is not equal to or more than the limit value Cv (S136, NO), the setting management part 26 transmits a caution notification to the portable terminal 8 (S140), and thereafter the setting management part 26 moves the process to step S126. The input part 35 of the portable terminal 8 receiving the caution notification displays the received caution notification on the second touch panel 9, and the input part 35 continues the process for acquiring the lower limit value Lv.

Moreover, on the other hand, at the time when the input lower limit value Lv in step S116 is not less than a present remaining amount of the on-vehicle battery 2, or the input lower limit value Lv is not equal to or more than the limit value Cv (S116, NO), the display control part 25 displays a caution notification on the first touch panel 10 (S134), and afterwards the display control part 25 moves the process to step S114.

Moreover, on the other hand, at the time when a display instruction of the lower limit value setting screen is not input in step S110, for example, at the time when an instruction of a display being unnecessary of the lower limit value setting screen is input (S110, NO), the first processor 20 executes a previous lower limit value determination process (S132), and thereafter the first processor 20 moves the process to step S120.

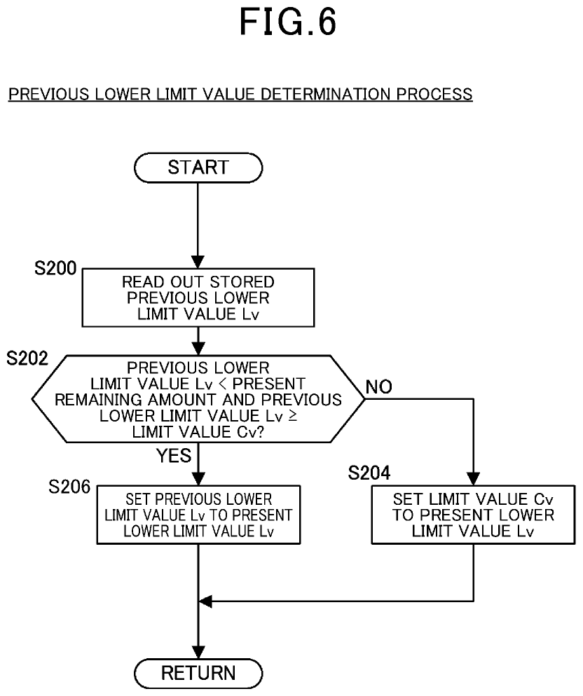

FIG. 6 is a flow chart showing procedures of processes of the previous lower limit value determination process shown in step S132 of FIG. 5.

When the process starts, the power supply control part 24 reads out the lower limit value Lv (hereinafter, called the previous lower limit value Lv) from the first memory 21, the lower limit value Lv being stored in the first memory 21 in step S120 (FIG. 5) at the time of a previous external power supply (S200). The setting management part 26 determines whether or not the read-out previous lower limit value Lv is less than the present remaining amount of the on-vehicle battery 2, and whether or not the read-out previous lower limit value Lv is equal to or more than the limit value Cv (S202).

Then, at the time when the previous lower limit value Lv is less than the present remaining amount of the on-vehicle battery 2, and the previous lower limit value Lv is equal to or more than the limit value Cv (S202, YES), the setting management part 26 sets the previous lower limit value Lv in the power supply control part 24 as a present lower limit value Lv (S206), and the setting management part 26 finishes the present process.

On the other hand, at the time when the previous lower limit value Lv is not less than the present remaining amount of the on-vehicle battery 2 or the previous lower limit value Lv is not equal to or more than the limit value Cv (S202, NO), the setting management part 26 sets the limit value Cv calculated in step S120 (FIG. 4) in the power supply control part 24 as a present lower limit value Lv (S204), and the setting management part 26 finishes the present process.

Here, in FIG. 4 to FIG. 6, step S100 corresponds to a detection step in the present disclosure. Moreover, steps S108 and S112 each correspond to a display control step in the present disclosure. Moreover, steps S126 and S128 each correspond to a power supply step in the present disclosure.

Note that the present invention is not limited to the configurations of the above described embodiments, and the above described embodiments can be implemented in various states within a range that does not deviate from the content of the present invention.

### [Configurations Supported by the Embodiments]

The above-stated embodiments support the following configurations.

(Configuration 1) A power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value during external power supply, a display control part for displaying a lower limit value setting screen on an on-vehicle display device mounted in the vehicle, the lower limit value setting screen being a screen for setting the lower limit value, and a detection part for detecting a start of the external power supply, wherein at a time when a start of the external power supply is detected, the display control part displays a confirmation screen on the on-vehicle display device, the confirmation screen for inquiring whether or not to display the lower limit value setting screen.

According to the power supply control device of Configuration 1, when an external power supply is performed from an on-vehicle battery to outside of a vehicle, a user can appropriately set, without forgetting, a lower limit value of power that can be supplied of the on-vehicle battery as a stopping condition of the external power supply. Accordingly, for example, a situation can be avoided in which a power suppliable remaining amount of the on-vehicle battery is depleted after an external power supply due to forgetting to set a lower limit value, and a vehicle can no longer travel.

(Configuration 2) The power supply control device described in Configuration 1, in which at a time when any one predetermined prescribed notification screen is displayed on the on-vehicle display device, the display control part does not display the confirmation screen on the on-vehicle display device even at a time when a start of the external power supply is detected.

According to the power supply control device of Configuration 2, by setting a screen of a warning notification or a screen of a failure notification beforehand as a prescribed notification screen, the screen of a warning notification or the screen of a failure notification to be notified to a user with priority, for example, a situation can be avoided in which a notification with a high priority is no longer conveyed to a user due to a display of a confirmation screen.

(Configuration 3) The power supply control device described in Configuration 2, in which at a time when the prescribed notification screen is displayed on the on-vehicle display device, and at a time when a start of the external power supply is detected, the display control part displays the confirmation screen on the on-vehicle display device at a time when a display of the prescribed notification screen is finished.

According to the power supply control device of Configuration 3, since a confirmation screen is displayed at the time when it is no longer necessary to display a prescribed notification screen such as a failure notification screen or a warning notification screen, for example, forgetting to input a lower limit value can be avoided, while surely performing a conveyance of a notification with high priority to a user, the lower limit value being a stopping condition of an external power supply.

(Configuration 4) A power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value, a detection part for detecting a start of the external power supply, and a setting management part for acquiring the lower limit value input from an input device, and the setting management part for setting the acquired lower limit value in the power supply control part, wherein the power supply control part stores the lower limit value set from the setting management part, and at a time when the lower limit value is not newly set from the setting management part after a start of the external power supply is detected, the power supply control part reads out a lower limit value set and stored by the setting management part at a time of a previous external power supply, and at a time when a power suppliable remaining amount of the on-vehicle battery becomes less than the read-out lower limit value, the power supply control part stops the external power supply.

According to the power supply control device of Configuration 4, since an external power supply is stopped by using a lower limit value at the time of a previous external power supply operation, even in the case where a user does not set a lower limit value at the time of a start of an external power supply, a situation can be avoided in which a power suppliable remaining amount of the on-vehicle battery is depleted after an external power supply, and a vehicle can no longer travel.

(Configuration 5) A power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value, and a setting management part for acquiring the lower limit value input from an input device, and the setting management part for setting the acquired lower limit value in the power supply control part, wherein at a time when the input lower limit value is a value exceeding a present power suppliable remaining amount of the on-vehicle battery, the setting management part does not set the acquired lower limit value in the power supply control part.

According to the power supply control device of Configuration 5, an inconvenient situation can be avoided in which a set lower limit value exceeds a present power suppliable remaining amount of an on-vehicle battery, and an external power supply operation immediately stops by the lower limit value.

(Configuration 6) The power supply control device described in Configuration 5, in which at a time when the lower limit value is a value equal to or more than a present power suppliable remaining amount, the lower limit value being input by a user of the vehicle by the input device, the setting management part notifies to the user a notification of not accepting a setting of the input lower limit value.

According to the power supply control device of Configuration 6, since a lower limit value input by a user being inappropriate is notified to the user, for example, an input error of a lower limit value by the user can be prevented, and the convenience of the user is improved.

(Configuration 7) The power supply control device described in Configuration 5 or 6, in which at a time when the lower limit value is a value less than a prescribed limit value, the lower limit value being input by a user of the vehicle by the input device, the setting management part notifies to the user a notification of not accepting a setting of the input lower limit value.

According to the power supply control device of Configuration 7, if a lower limit value input by a user is too small, for example, a situation can be avoided in which hardly any power suppliable remaining amount of an on-vehicle battery remains after an external power supply, and afterwards a vehicle can no longer travel to a planned location.

(Configuration 8) The power supply control device described in Configuration 7, in which the setting management part calculates a power suppliable remaining amount of the on-vehicle battery necessary for the vehicle to travel a distance from a present position to a destination, and the setting management part determines a value of the calculated power suppliable remaining amount as the limit value.

According to the power supply control device of Configuration 8, a user can set an appropriate lower limit value, so that a power suppliable remaining amount of an on-vehicle battery necessary for a vehicle to travel to a destination after an external power supply can be secured.

(Configuration 9) The power supply control device described in Configuration 7, in which the setting management part calculates a power suppliable remaining amount of the on-vehicle battery necessary for the vehicle to travel a distance from a present position to a nearest energy refill station, and the setting management part determines a value of the calculated power suppliable remaining amount as the limit value.

According to the power supply control device of Configuration 9, a user can set an appropriate lower limit value, so that a power suppliable remaining amount of an on-vehicle battery necessary for a vehicle to travel to a nearest energy refill station after an external power supply can be secured.

(Configuration 10) The power supply control device described in Configuration 8 or 9, in which the setting management part estimates a power consumption of the vehicle in an environment based on environmental information including a temperature of a region, the environment being shown by the environment information and the region including a present position of the vehicle, and the setting management part calculates the necessary power suppliable remaining amount of the on-vehicle battery by using the estimated power consumption.

According to the power supply control device of Configuration 10, when determining a limit value, since a necessary power suppliable remaining amount after an external power supply is calculated based on an environmental condition such as temperature that can have an influence on a power consumption of a vehicle, the necessary power suppliable remaining amount can be appropriately calculated. In this way, in the power supply control device of Configuration 10, a situation can be avoided in which a vehicle can no longer travel to a destination or a nearest energy refill station, regardless of a user setting a lower limit value equal to or more than a limit value.

(Configuration 11) A power supply control device including a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value, a detection part for detecting a start of the external power supply, and a setting management part for acquiring the lower limit value input from an input device, and the setting management part for setting the acquired lower limit value in the power supply control part, wherein at a time when a power suppliable remaining amount of the on-vehicle battery becomes less than a presently set lower limit value, the power supply control part stops the external power supply until the lower limit value is newly set from the setting management part.

According to the power supply control device of Configuration 11, since a user can, for example, set an appropriate lower limit value beforehand prior to an external power supply starting, the convenience of the user is improved.

(Configuration 12) The power supply control device described in any one of Configurations 4 to 11, in which the input device is an input device included in a portable terminal of a user of the vehicle.

According to the power supply control device of Configuration 12, an external power supply operation can be stopped, by using a lower limit value input from an input device of a portable terminal by a user. In this way, since the user can input a lower limit value even at a location where the user is separated from a vehicle, the convenience of the user is improved.

(Configuration 13) The power supply control device described in any one of Configurations 1 to 12, in which at a time when the external power supply stops, the power supply control part transmits a notification of a power supply stop to a portable terminal of a user of the vehicle.

According to the power supply control device of Configuration 13, since a user can know that an external power supply operation has stopped even if the user is separated from a vehicle, the convenience of the user is improved.

(Configuration 14) A power supply control method performed by a computer of a power supply control device, the power supply control method including a power supply step for controlling an external power supply from an on-vehicle battery mounted in a vehicle, the external power supply being a power supply to outside of the vehicle, and the power supply step for stopping the external power supply at a time when a power suppliable remaining amount of the on-vehicle battery becomes less than a predetermined lower limit value during external power supply, a display control step for displaying a lower limit value setting screen on an on-vehicle display device mounted in the vehicle, the lower limit value setting screen being a screen for setting the lower limit value, and a detection step for detecting a start of the external power supply, wherein in the display control step, at a time when a start of the external power supply is detected in the detection step, a confirmation screen is displayed on the on-vehicle display device, the confirmation screen for inquiring whether or not to display the lower limit value setting screen.

According to the power supply control method of Configuration 14, when an external power supply is performed from an on-vehicle battery to outside of a vehicle, a user can appropriately set, without forgetting, a lower limit value of power that can be supplied of the on-vehicle battery as a stopping condition of the external power supply. Accordingly, for example, a situation can be avoided in which a power suppliable remaining amount of the on-vehicle battery is depleted after an external power supply due to forgetting to set a lower limit value, and a vehicle can no longer travel.

### REFERENCE SIGNS LIST

1 power supply control device
2 on-vehicle battery
3 vehicle
4 drive motor
5 building
6 building battery
7 communication network
8 portable terminal
9 second touch panel
10 first touch panel
11 communication unit
12 navigation device
13 map information
14 power supply circuit
141 power supply switch
15 power supply sensor
16 remaining amount sensor
17 vehicle control device
18 external power supply connector
19 fuel port
20 first processor
21 first memory
22 power consumption information
23 detection part
24 power supply control part
25 display control part
26 setting management part
30 second processor
31 second memory
32 communication device
34 program
35 input part
36 notification part
40 confirmation message
41 YES button
42 NO button
43 message
44 lower limit value adjustment bar
45 remaining amount display bar
46 gauge
47 minus button
48 plus button
49 caution notification
50 button group

What is claimed is:

1. A power supply control device, comprising:
a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value during external power supply;
a display control part for displaying a lower limit value setting screen on an on-vehicle display device mounted in the vehicle, the lower limit value setting screen being a screen for setting the lower limit value; and
a detection part for detecting a start of the external power supply, wherein
at a time when a start of the external power supply is detected, the display control part displays a confirmation screen on the on-vehicle display device, the confirmation screen for inquiring whether or not to display the lower limit value setting screen.

2. The power supply control device according to claim 1, wherein
at a time when any one predetermined prescribed notification screen is displayed on the on-vehicle display device, the display control part does not display the confirmation screen on the on-vehicle display device even at a time when a start of the external power supply is detected.

3. The power supply control device according to claim 2, wherein
at a time when the prescribed notification screen is displayed on the on-vehicle display device, and at a time when a start of the external power supply is detected, the display control part displays the confirmation screen on the on-vehicle display device at a time when a display of the prescribed notification screen is finished.

4. A power supply control device, comprising:
a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value;
a detection part for detecting a start of the external power supply; and
a setting management part for acquiring the lower limit value input from an input device, and the setting management part for setting the acquired lower limit value in the power supply control part, wherein
the power supply control part stores the lower limit value set from the setting management part, and at a time when the lower limit value is not newly set from the setting management part after a start of the external power supply is detected, the power supply control part reads out a lower limit value set and stored by the setting management part at a time of a previous external power supply, and at a time when a power suppliable remaining amount of the on-vehicle battery becomes less than the read-out lower limit value, the power supply control part stops the external power supply.

5. A power supply control device, comprising:
a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value; and
a setting management part for acquiring the lower limit value input from an input device, and the setting management part for setting the acquired lower limit value in the power supply control part, wherein
at a time when the input lower limit value is a value exceeding a present power suppliable remaining amount of the on-vehicle battery, the setting management part does not set the acquired lower limit value in the power supply control part.

6. The power supply control device according to claim 5, wherein
at a time when the lower limit value is a value equal to or more than a present power suppliable remaining amount, the lower limit value being input by a user of the vehicle by the input device, the setting management part notifies to the user a notification of not accepting a setting of the input lower limit value.

7. The power supply control device according to claim 5, wherein
at a time when the lower limit value is a value less than a prescribed limit value, the lower limit value being input by a user of the vehicle by the input device, the setting management part notifies to the user a notification of not accepting a setting of the input lower limit value.

8. The power supply control device according to claim 7, wherein
the setting management part calculates a power suppliable remaining amount of the on-vehicle battery necessary for the vehicle to travel a distance from a present position to a destination, and the setting management part determines a value of the calculated power suppliable remaining amount as the limit value.

9. The power supply control device according to claim 7, wherein
the setting management part calculates a power suppliable remaining amount of the on-vehicle battery necessary for the vehicle to travel a distance from a present position to a nearest energy refill station, and the setting management part determines a value of the calculated power suppliable remaining amount as the limit value.

10. The power supply control device according to claim 8, wherein
the setting management part estimates a power consumption of the vehicle in an environment based on environmental information including a temperature of a region, the environment being shown by the environment information and the region including a present position of the vehicle, and the setting management part calculates the necessary power suppliable remaining amount of the on-vehicle battery by using the estimated power consumption.

11. A power supply control device, comprising:
a power supply control part for controlling an external power supply from an on-vehicle battery mounted in a vehicle, the external power supply being a power supply to outside of the vehicle, and the power supply control part for stopping the external power supply at a time when a power suppliable remaining amount of the on-vehicle battery becomes less than a predetermined lower limit value;
a detection part for detecting a start of the external power supply; and
a setting management part for acquiring the lower limit value input from an input device, and the setting management part for setting the acquired lower limit value in the power supply control part, wherein
at a time when a power suppliable remaining amount of the on-vehicle battery becomes less than a presently set lower limit value, the power supply control part stops the external power supply until the lower limit value is newly set from the setting management part.

12. The power supply control device according to claim 4, wherein
the input device is an input device included in a portable terminal of a user of the vehicle.

13. The power supply control device according to claim 1, wherein
at a time when the external power supply stops, the power supply control part transmits a notification of a power supply stop to a portable terminal of a user of the vehicle.

14. A power supply control method performed by a computer of a power supply control device, the power supply control method comprising:
a power supply step for controlling an external power supply from an on-vehicle battery mounted in a vehicle, the external power supply being a power supply to outside of the vehicle, and the power supply step for stopping the external power supply at a time when a power suppliable remaining amount of the on-vehicle battery becomes less than a predetermined lower limit value during external power supply;
a display control step for displaying a lower limit value setting screen on an on-vehicle display device mounted in the vehicle, the lower limit value setting screen being a screen for setting the lower limit value; and
a detection step for detecting a start of the external power supply, wherein
in the display control step, at a time when a start of the external power supply is detected in the detection step, a confirmation screen is displayed on the on-vehicle display device, the confirmation screen for inquiring whether or not to display the lower limit value setting screen.
